(19) United States
(12) Patent Application Publication
(10) Pub. No.: US 2009/0258630 A1
(43) Pub. Date: Oct. 15, 2009

(54) SYSTEM AND METHOD FOR INTELLIGENT SYNTAX MATCHING

(75) Inventor: Manoj Kumar Purohit, Singapore (SG)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Reston, VA (US)

(21) Appl. No.: 12/423,245

(22) Filed: Apr. 14, 2009

Related U.S. Application Data
(60) Provisional application No. 61/045,049, filed on Apr. 15, 2008.

(51) Int. Cl. H04M 11/00; H04W 4/12

(52) U.S. Cl. 455/406; 455/466

(57) ABSTRACT

The ubiquitous nature of wireless devices has given rise to among other things an explosive growth in messaging including, among other categories of messaging, Application-to-Peer messaging. It is inevitable that various errors (e.g., misspellings, typographic errors, transpositions, etc.) will occur as a mobile subscriber adds one or more keywords, codes, indicators, responses, etc. to an Application-to-Peer message. An error-laden message will likely be dropped, discarded, ignored, etc. when it is processed contributing to among other things a poor user experience. An infrastructure that offers possibly among other things an intelligent syntax matching capability accommodates (by, for example, automatically identifying, correcting or otherwise resolving, etc.) such errors so that messages containing such errors may be processed. The infrastructure may optionally leverage the capabilities of a centrally-located Messaging Inter-Carrier Vendor.

This application claims the benefit of U.S. Provisional Patent Application Ser. No. 61/045,049, filed on 15 Apr. 2008, which is herein incorporated by reference in its entirety.

### BACKGROUND

1. Field of the Invention

The present invention relates generally to telecommunications services. More particularly, the present invention relates to capabilities that enhance substantially the value and usefulness of various messaging paradigms including, inter alia, Short Message Service (SMS), Multimedia Message Service (MMS), Internet Protocol (IP) Multimedia Subsystem (IMS), etc.

2. Background of the Invention

As the ‘wireless revolution’ continues to march forward the importance to a Mobile Subscriber (MS)—for example a user of a Wireless Device (WD) that is serviced by possibly inter alia a Wireless Carrier (WC)—of their WD grows substantially. Examples of WDs include, possibly inter alia, mobile telephones, handheld computers, Internet-enabled telephones, pagers, net appliances, mini-browsers, Personal Digital Assistants (PDAs), etc.

One consequence of such a growing importance is the resulting ubiquitous nature of WDs—i.e., MSs carry them at almost all times and use them for an ever-increasing range of activities. For example, as reported by the industry group CTIA (see ctia.org on the World Wide Web [WWW]) as of January 2008 there were in the U. S. just under 254 million WD users.

Coincident with the expanding presence of WDs has been the explosive growth of messaging—a steady annual increase, year over year, in the number of (SMS, MMS, etc.) messages that have been exchanged by and between WDs. That steady increase shows no sign of abating. For example, as reported by the industry group CTIA (see ctia.org on the WWW) in the U. S. there were over 158 billion SMS messages sent during 2006 (representing a 95% increase over 2005) and there were over 2.7 billion MMS messages sent during 2006 (representing a 100% increase over 2005).

The messaging that was quantified above may be categorized broadly as Peer-to-Peer (or P2P) communication—wherein for example one peer, MS₁, may employ their WD (which is serviced perhaps by WC₁) to send messages to the WD of another peer, MS₂, (whose WD is serviced perhaps by WC₂) and MS₂ may optionally reply to the received messages—and Application-to-Peer (A2P) communication—wherein a peer, MS₁, may employ their WD (which is serviced perhaps by WC₁) to send messages to and/or receive messages from an application or a system that may reside within a Service Provider (SP).

Illustrative examples of A2P communication include, possibly inter alia, content distribution mechanisms wherein a MS may employ their WD to subscribe to, request, confirm, authorize, etc. the distribution of content (which might include, possibly inter alia, news items, traffic alerts, weather notices, travel advisories, stock quotations, advertisements, coupons, educational factoids, etc.) to their WD; voting initiatives (such as the initiative that is offered by the television show American Idol®) wherein a MS may employ their WD to register a vote; trivia campaigns wherein a MS may employ their WD to submit an answer or a response to a trivia question; etc.

The specific examples that were described above are illustrative only and it will be readily apparent to one of ordinary skill in the relevant art that numerous other examples are easily possible and indeed are fully within the scope of the present invention.

During an A2P message exchange a MS will often need to compose a (SMS, MMS, etc.) message; address their message to a SP; and include in their message one or more keywords, codes, indicators, responses, etc. (that an application or system that is present within a SP may extract, evaluate, process, etc.).

Inevitably various errors—including possibly inter alia misspellings, typographic errors, transpositions, etc.—may occur as a MS adds one or more keywords, codes, indicators, responses, etc. to their message. Indeed, empirical evidence suggests that a frequency of error-laden messages between 20%-40% is not uncommon.

An error-laden message will likely be dropped, discarded, ignored, etc. when it is processed by a SP's application(s) or system(s). A SP's dropping, discarding, ignoring, etc. of error-laden messages contributes to, possibly inter alia, a poor MS user experience—e.g., a SP may elect not to notify a MS that a message that was received from the MS will not be processed (leaving the MS assuming that their message was, in fact, processed); a SP may notify a MS that a message that was received from the MS will not be processed (requiring that the MS compose and dispatch, as well as pay for, another message); etc.

What is needed is an intelligent syntax matching capability that a SP's application(s) or system(s) can employ to, possibly among other things, accommodate (by, for example, possibly inter alia automatically identifying, correcting or otherwise resolving, etc.) such errors so that messages containing such errors that are received by a SP may be processed.

The present invention provides such intelligent syntax matching and addresses, in new and innovatory ways, various of the (not insubstantial) challenges that are associated with same.

### SUMMARY OF THE INVENTION

One embodiment of the present invention offers a method for intelligent syntax matching that includes possibly inter alia (1) receiving at a gateway an incoming message (the incoming message containing at least a body and having originally been initiated by a mobile subscriber as a wireless message directed to an A2P initiative), (2) performing one or more processing steps (using two or more of (a) aspects of the incoming message, (b) information about the mobile subscriber, and (c) parse rules for the A2P initiative) to identify an error in the body of the incoming message and identify a correction to the error, (3) alerting the mobile subscriber to the correction and, based on any reply from the mobile subscriber, accepting either the correction or an alternative correction supplied by the mobile subscriber, and (4) updating aspects of an internal repository.

Another embodiment of the present invention offers a system for intelligent syntax matching that includes possibly inter alia (1) a gateway at which an incoming message is received (the incoming message containing at least a body and having originally been initiated by a mobile subscriber as a wireless message directed to an A2P initiative) and (2) one or more workflow modules, the workflow modules being operable to (a) perform one or more processing steps (using two or more of (i) aspects of the incoming message, (ii) information about the mobile subscriber, and (iii) parse rules for the A2P initiative) to (i) identify an error in the body of the incoming message and (ii) identify a correction to the error, (b) alert the mobile subscriber to the correction and, based on any reply from the mobile subscriber, accept either the correction or an alternative correction supplied by the mobile subscriber, and (c) update aspects of an internal repository.

These and other features of the embodiments of the present invention, along with their attendant advantages, will be more fully appreciated upon a reading of the following detailed description in conjunction with the associated drawings.

### BRIEF DESCRIPTION OF THE DRAWINGS

The accompanying drawings, which are incorporated herein and form part of the specification, depict embodiments of the present invention and, together with the summary that was presented above and the description that may be found below, further serve to illustrate inter alia the principles, structure, and operation of such embodiments. It will be readily apparent to one of ordinary skill in the relevant art that numerous variations, modifications, alternative forms, etc. of the depicted embodiments are easily possible and indeed are within the scope of the present invention.

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are possible during an optional registration portion of the present invention.

FIG. 4 illustrates various of the exchanges or interactions that are supported by aspects of the present invention.

FIG. 5 depicts aspects of an illustrative parse rule implementation.

FIG. 6 is a diagrammatic presentation of aspects of an exemplary SP Application Server (AS).

FIG. 7 provides an exemplary catalog of various of the shortcuts that are frequently employed in SMS, MMS, etc. messages.

### DETAILED DESCRIPTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, along with its associated continuations, is incorporated herein by reference.

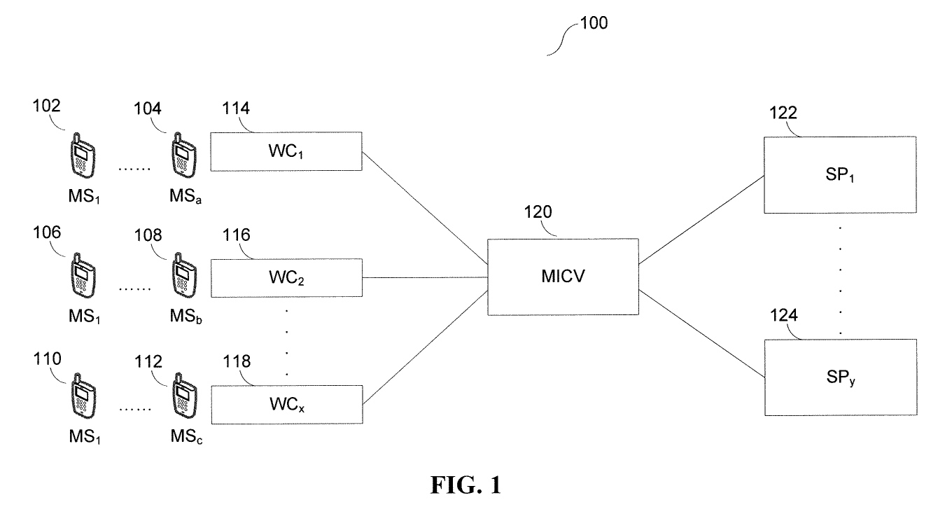

As illustrated in FIG. 1 and reference numeral 100 a MICV 120 is disposed between, possibly inter alia, multiple WCs (WC₁ 114, WC_{2 116→WC}ₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, 110→112 that are serviced by the WC 114→118) with ubiquitous access to a broad universe of SPs 122→124, and

2) A SP 122→124 with ubiquitous access to a broad universe of WCs 114→118 (and, by extension, to all of the MSs 102→104, 106→108, 110→112 that are serviced by the WCs 114→118).

Generally speaking a MICV may have varying degrees of visibility (e.g., access, etc.) to the (MS←→MS, MS←→SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV, it will be readily apparent to one of ordinary skill in the relevant art that other arrangements are equally applicable and indeed are fully within the scope of the present invention.

In the discussion below aspects of the present invention are described and illustrated as being offered by a SP. A SP may, for example, be realized through the combination of, possibly inter alia, any one or more of a Third-Party (3P) service bureau, an element of a WC, an element of a landline carrier, an element of a MICV, multiple entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example. Our hypothetical example includes, possibly inter alia, (1) SPₓ (a SP that offers a service that has been enhanced or augmented as provided through aspects of the instant invention) and (2) numerous MSs including one specific individual MS, Mary.

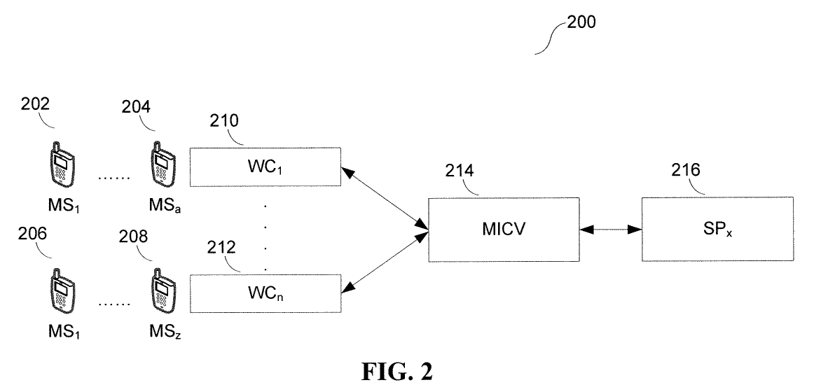

FIG. 2 and reference numeral 200 depict one particular arrangement that may be possible under our hypothetical example. As the diagram portrays, the messaging traffic of numerous MSs (MS₁ 202→MSₐ 204 and MS₁ 206→MS_{z} 208, including Mary), that are serviced by WCs WC₁ 210→WCₙ 212, is exchanged with a MICV 214 and the MICV 214 is connected with SPₓ 216 (a SP that offers, possibly inter alia, aspects of the present invention).

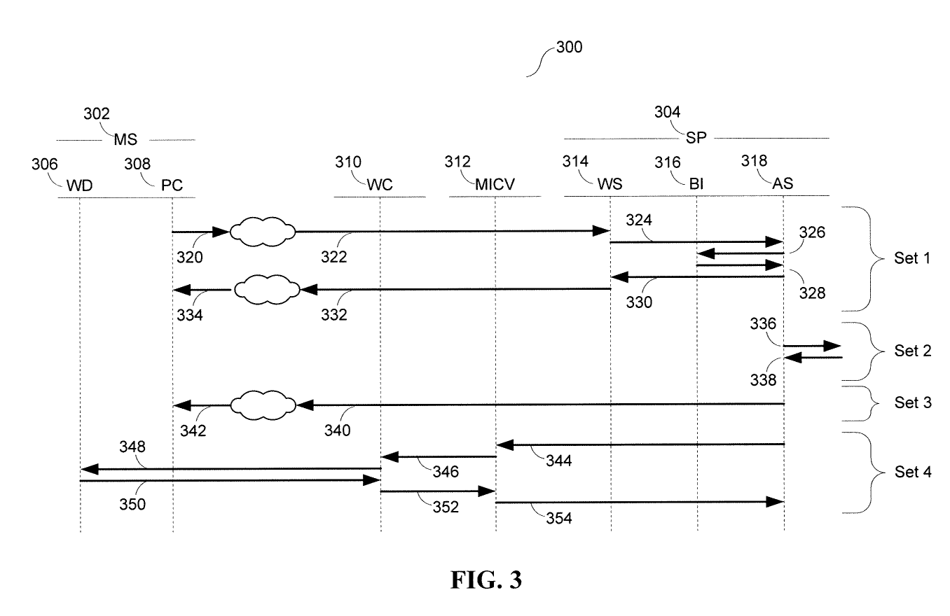

FIG. 3 and reference numeral 300 illustrate various of the exchanges or interactions that might occur under an optional registration portion of our hypothetical example. Among other things a registration process may be tailored (e.g., the range of information gathered, the scope of services subsequently offered, etc.) to the class of user—e.g., possibly inter alia different types, categories, etc. of users (ordinary MS, WC or MICV representative, SP representative, etc.) may complete different registration processes. Of interest and note in the diagram are the following entities:

MS 302 WD 306. For example, Mary's 302 WD such as mobile telephone, BlackBerry, PalmPilot, etc.

MS 302 Personal Computer (PC) 308. For example, one of Mary's 302 home, work, etc. PCs.

WC 310. The provider of service for Mary's 302 WD 306.

MICV 312. As noted above the use of a MICV, although not required, provides significant advantages.

SP 304 Web Server (WS) 314. A publicly-available WWW site that is optionally provided by SPₓ 304.

SP 304 Billing Interface (BI) 316. A single, consolidated interface that SPₓ 304 may use to easily reach, inter alia, one or more external entities such as a credit card or debit card clearinghouse, a carrier billing system, a service bureau that provides access to multiple carrier billing systems, etc.

SP 304 AS 318. Facilities that provide key elements of the instant invention (which will be described below).

It is important to note that while in FIG. 3 the MS 302 WD 306 and MS 302 PC 308 entities are illustrated as being adjacent or otherwise near each other, in actual practice the entities may, for example, be physically located anywhere.

In FIG. 3 the exchanges that are collected under the designation Set 1 represent the activities that might take place as Mary 302 completes a registration process with SPₓ 304:

A) Mary 302 uses one of her PCs 308 to visit SPₓ's 304 WS 314 to, possibly among other things, complete a service registration process (320→322).

B) SPₓ's 304 WS 314 interacts with SPₓ's 304 AS 318 to, possibly among other things, commit some or all of the information that Mary 302 provided to a data repository (e.g., a database), optionally complete a billing transaction, etc. (324).

C) As appropriate and as required a BI 316 completes a billing transaction (326→328).

D) After receiving a response from SPₓ's 304 AS 318 (330) SPₓ's 304 WS 314 responds appropriately (e.g., with the presentation of a confirmation message, etc.) (332→334).

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms. For example, the registration process may be completed through any combination of one or more channels including, inter alia, the WWW (via, for example, a Web site that is operated by SPₓ 304), wireless messaging (SMS, MMS, etc.), Electronic Mail (E-Mail) messages, Instant Messaging (IM), conventional mail, telephone, Interactive Voice Response (IVR) facility, etc.

During the registration process described above a range of information may be captured from a MS including, inter alia:

A) Identifying Information. For example, possibly among other things, name, address, age, sex, a unique identifier and a password, WD Telephone Number (TN), content preferences, etc.

B) Billing Information. Different service billing models may be offered including, inter alia, no charge, a fixed one-time charge, a recurring (monthly, etc.) fixed charge, a recurring (monthly, etc.) variable charge, a per-event charge, etc. Different payment mechanisms may be supported including, possibly among other things, credit or debit card information, authorization to place a charge on a MS's phone bill, authorization to deduct funds from a MS′ (bank, brokerage, etc.) account, etc.

The specific pieces of information that were described above are illustrative only and it will be readily apparent to one of ordinary skill in the relevant art that numerous other pieces of information (e.g., additional Identifying Information, WD feature or function details, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS profile.

The content of Mary's profile may be augmented by SPₓ to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, a financial institution, etc.). The billing transaction may include, possibly inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

3) The (electronic, etc.) transfer of funds.

4) The generation of an invoice, statement, etc.

In FIG. 3 the exchanges that are collected under the designation Set 2 represent the activities that might take place as SPₓ 304 optionally coordinates, etc. with one or more external entities (such as, for example, a 3P, etc.) to, possibly among other things, secure access, confirm collected information, arrange to receive updates, etc. (see 336→338).

The specific exchanges that were described above (as residing under the designation Set 2) are illustrative only and it will be readily apparent to one of ordinary skill in the relevant art that numerous other exchanges (including, inter alia, updates to various of the information in a MS Profile in a SP's repository, etc.) are easily possible and indeed are fully within the scope of the present invention.

In FIG. 3 the exchanges that are collected under the designation Set 3 represent the activities that might take place as SPₓ's 304 AS 318 dispatches to Mary 302 one or more confirmation E-Mail messages (340→342).

The specific exchanges that were described above (as residing under the designation Set 3) are illustrative only and it will be readily apparent to one of ordinary skill in the relevant art that numerous other exchanges are easily possible and indeed are fully within the scope of the present invention.

In FIG. 3 the exchanges that are collected under the designation Set 4 represent the activities that might take place as SPₓ's 304 AS 318 dispatches one or more confirmation SMS, MMS, etc. messages to Mary's 302 WD 306 (344→348) and Mary 302 optionally replies or responds to the message(s) (350→354). Of interest and note are:

1) In the instant example the messages are shown traversing a MICV 312.

2) The SP 304 may employ a Short Code (SC) or a regular TN as its source address (and to which it would ask users of its service to direct any reply messages). While the abbreviated length of a SC (e.g., five digits for a SC administered by Neustar under the Common Short Code [CSC] program) incrementally enhances the experience of a MS 302 (e.g., the MS 302 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention. For example, possibly inter alia, the registration information that was described above may subsequently be managed (e.g., existing information may be edited or removed, new information may be added, etc.) through any combination of one or more channels including, inter alia, a SP's WWW facility, wireless messaging (SMS, MMS, etc.), E-Mail messages, IM exchanges, conventional mail, telephone, IVR facilities, etc.

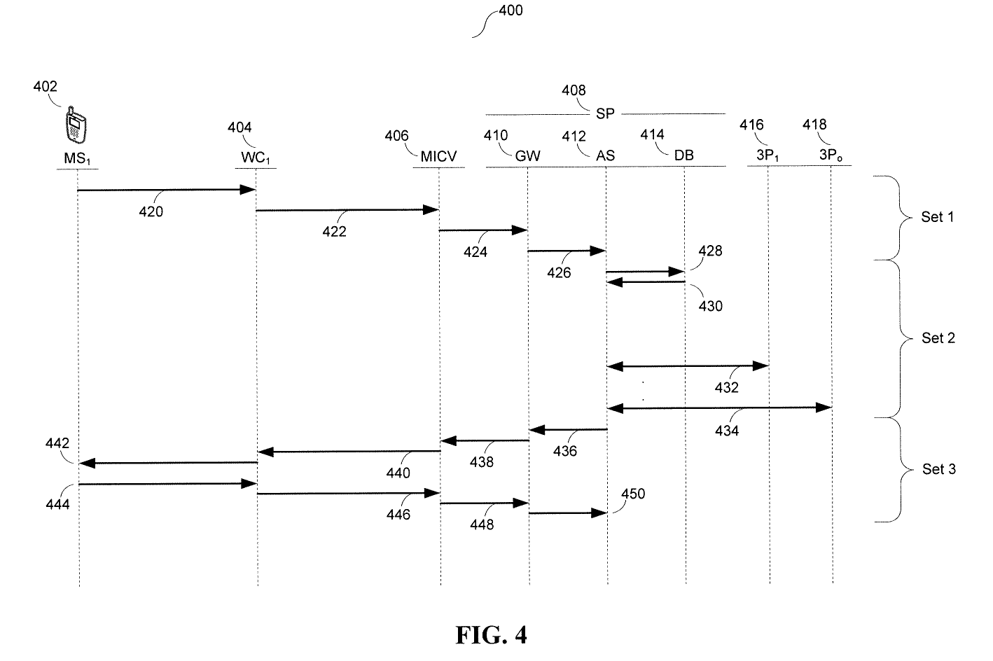

To continue with our hypothetical example . . . after Mary completes an optional registration process (as described above) she may begin to create, send, receive, reply to, etc. (SMS, MMS, etc.) A2P messages. This portion of our hypothetical example may be examined through FIG. 4 and reference numeral 400. Of interest and note in FIG. 4 are:

MS₁ 402. The WD of Mary, our hypothetical MS.

WC₁ 404. The provider of service for Mary's WD 402.

MICV 406. As noted above the use of a MICV, although not required, provides significant advantages.

SP 408 Gateway (GW) 410. An interface through which SPₓ 408 may possibly inter alia receive and send SMS/MMS/etc. messages.

SP 408 AS 412. Facilities that provide key elements of the instant invention (which will be described below).

SP 408 Database (DB) 414. An internal repository that a SPₓ 408 may use to store possibly inter alia MS information.

3P₁ 416→3Pₒ 418. Various 3Ps that may possibly inter alia provide WC billing system access, provide billing-related services, serve as content sources, etc.

As noted above an internal repository 414 may contain, possibly inter alia, MS information. This portion of such a repository might contain possibly inter alia aspects or elements of the MS profile that was described previously during the discussion of the optional registration process.

The exchanges that are collected under the designation Set 1 represent the activities that might take place as:

1) Mary 402 creates a (SMS/MMS/etc.) message and dispatches the message (420). The message might contain, possibly inter alia, a destination address (such as for example a SC, a TN, etc.), a body or payload (such as for example one or more keywords, codes, indicators, responses, etc.), etc.

2) The message is passed by Mary's 402 WC 404 to a MICV 406 (422).

3) The MICV 406 passes the message to a GW 410 of SPₓ 408 (424).

4) The GW 410 passes the message to an AS 412 of SPₓ 408 (426).

The specific exchanges that were described above (as residing under the designation Set 1) are illustrative only and it will be readily apparent to one of ordinary skill in the relevant art that numerous other exchanges are easily possible and indeed are fully within the scope of the present invention.

The exchanges that are collected under the designation Set 2 represent the activities that might take place as the AS 412 completes a series of processing steps, including possibly inter alia:

1) Extract various data elements from the received message such as possibly inter alia the source TN of the message to identify the originating MS; the body of the message (to capture for example one or more keywords, codes, indicators, responses, etc.); etc.

2) Leveraging a body of flexible, extensible, and dynamically configurable rules, procedures, etc. to optionally perform one or more edit, validation, etc. operations on the extracted data elements.

3) Leveraging a body of flexible, extensible, and dynamically configurable parse rules (described in detail below) iteratively complete one or more analysis, manipulation, transformation, replacement, etc. operations to possibly inter alia qualify, confirm, resolve, etc. each of any keywords, codes, indicators, responses, etc. so that the results are consistent with any rules, requirements, parameters, etc. that may be defined for an aspect of an A2P campaign, initiative, etc. (as preserved possibly inter alia in repository 414 and accessed via 428→430).

4) Optionally interact with one or more 3Ps (432→434) to possibly inter alia confirm details, send and/or receive updates, etc.

6) Optionally complete one or more billing operations (including possibly inter alia one or more of the forms or types that were described previously).

7) Optionally update one or more elements within an internal repository (including possibly inter alia aspects of one or more MS profiles).

The catalog of processing steps that was described above is illustrative only and it will be readily apparent to one of ordinary skill in the relevant art that numerous other processing steps are easily possible and indeed are fully within the scope of the present invention.

As noted above a SP's AS′ processing steps may employ parse rules. In brief, parse rules may possibly inter alia support the analysis, manipulation, transformation, etc. of one or more tokens (e.g., developed through the lexical analysis, tokenization, etc. of one or more keywords, codes, indicators, responses, etc.) to possibly inter alia qualify, confirm, resolve, etc. a token so that the results are consistent with any rules, requirements, etc. that may be defined for an aspect of an A2P campaign, initiative, etc. For example:

A) One or more parse rules might operate on the token ‘before’ to produce, possibly inter alia, one or more Of ‘bfore,’ ‘bfre,’ ‘bfr,’ or ‘b4.’

B) One or more parse rules might operate on the token ‘restaurant’ to produce, possibly inter alia, one or more of ‘rstaurant,’ ‘rsturant,’ ‘rstrant,’ or ‘rstrnt.’

C) One or more parse rules might operate on the token ‘hotel’ to produce, possibly inter alia, one or more of ‘htel’ or ‘htl.’

The specific examples that were presented above are illustrative only and it will be readily apparent to one of ordinary skill in the relevant art that numerous other examples are easily possible and indeed are fully within the scope of the present invention.

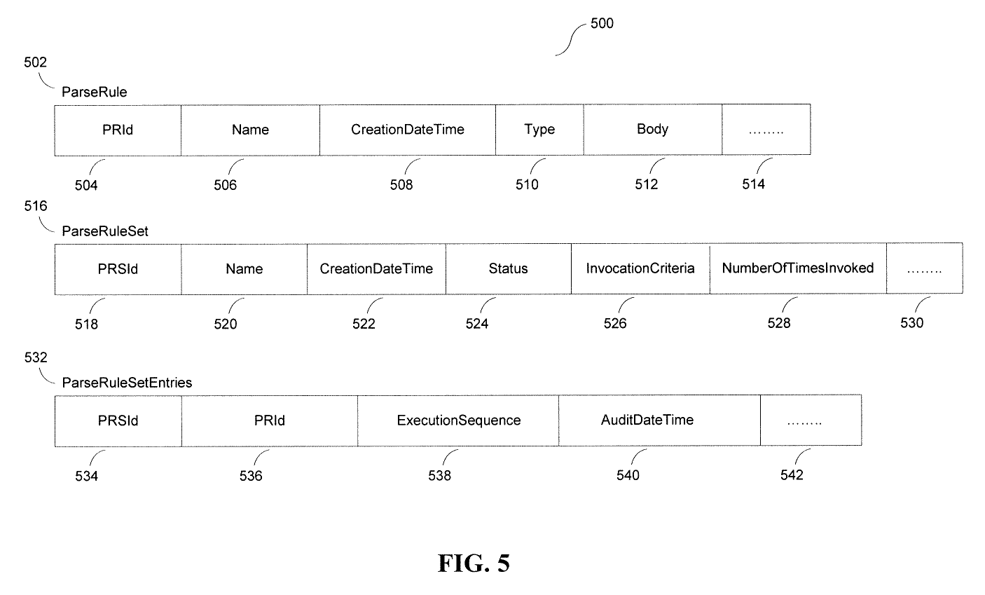

Aspects of an illustrative parse rule facility may be examined through FIG. 5 and reference numeral 500. Of interest and note are the following entities:

A) ParseRule 502. Information (such as possibly inter alia a unique internal identifier 504, name 506, creation date/time 508, type 510, body 512, etc. 514) for each defined parse rule. The body 512 of a ParseRule 502 may contain, for example and possibly inter alia, any combination of one or more of a regular expression, a general lexical analysis rule, a Parsing Expression Grammar (PEG), a Natural Language Processing (NLP) construct, a Context-Free Grammar (CFG), etc.

B) ParseRuleSet 516. Information (such as possibly inter alia unique identifier 518, name 520, creation date/time 522, status 524, invocation criteria 526, an invocation counter 528, etc. 530) for each defined parse rule set (i.e., set of one or more parse rules). Invocation criteria 526 may consist of, for example and possibly inter alia, any combination of one or more of Time of Day (ToD), Day of Week (DoW), message source, message destination, message context, etc.

C) ParseRuleSetEntries 532. One or more entries that capture for each parse rule set 534 possibly inter alia details such as the elements (i.e., parse rules) 536, execution sequence 538, etc. 540→542 of the set.

The illustrative organizational model that was described above is exemplary only and it will be readily apparent to one of ordinary skill in the relevant art that numerous other entities, entity arrangements, etc. are easily possible and indeed are fully within the scope of the present invention. For example, a parse rule might be defined to optionally include one or more weightings, scores, ratings, ranks, confidence factors, etc. that might be applied during execution of the parse rule.

Using the illustrative organizational model that was described above one might have (as one simple example):

| PRId | Name | Type | Body | . . . |
|---|---|---|---|---|
| 1001 | Replacement 1 | RPL | [“eat” = 3↑] [symbol] “8” | |
| 1002 | Replacement 2 | RPL | [“fore” = 4↑] [symbol] “4” | |
| 1003 | Condition 1 | CND | [“s” = ρ↑] | |
| . | | | | |
| . | | | | |
| . | | | | |

| PRSId | Name | Status | . . . |
|---|---|---|---|
| 2001 | Baseline A | Active | |
| . | | | |
| . | | | |
| . | | | |

| PRSId | PRId | Sequence | . . . |
|---|---|---|---|
| 2001 | 1001 | 1 | |
| 2001 | 1002 | 2 | |
| . | | | |
| . | | | |
| . | | | |

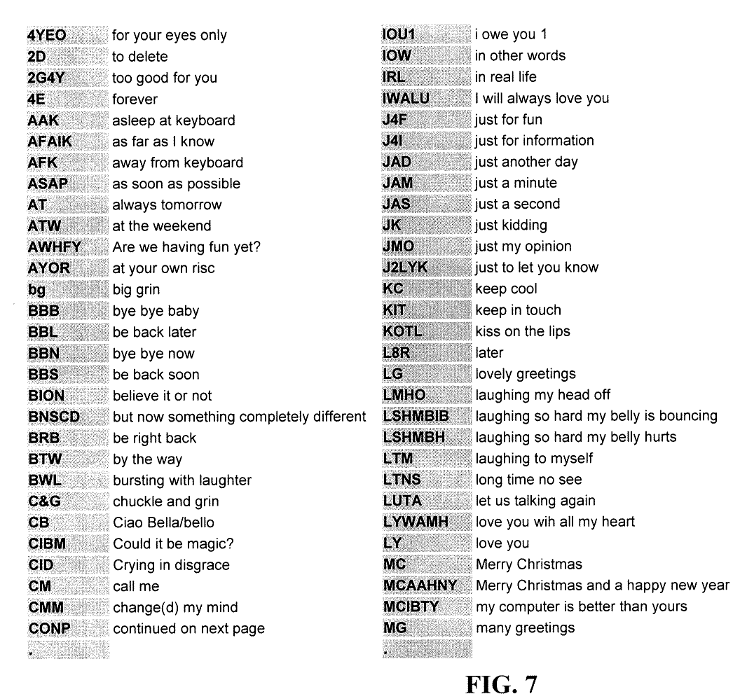

Under one embodiment of aspects of the present invention, exemplary parse rules (from which numerous parse rule sets may be constructed) may leverage possibly inter alia one or more resources (such as for example a list or catalog of shortcuts that are frequently included in [SMS, MMS, etc.] messages such as presented in FIG. 7, a catalog of word or phrase substitutions, a [English/French/German/Spanish/etc.] language dictionary, etc.) and may express one or more of the following actions for a token (e.g., developed from one or more of a keyword, code, indicator, response, etc.):

1) Remove all extraneous white-space from a token.

2) Retain just the first n (e.g., 2, 3, 4, etc.) characters of a token.

3) Retain just the last n (e.g., 2, 3, 4, etc.) characters of a token.

3) If a token contains, ends in, etc. a specified word fragment (e.g., “eat,” “fore,” etc.) then complete an indicated replacement (e.g., “8,” “4,” etc.).

4) If the final character of a token is an “s” then, depending on the penultimate character (e.g., whether it is a vowel, etc.), complete an indicated appending operation (e.g., append “es” to the token, append “'s” to the token, etc.).

5) Remove all occurrences of a vowel (e.g., a specific vowel, any vowel, etc.) from a token.

6) In any sequence of consecutive vowels in a token remove the entire sequence, remove the first occurrence of a vowel, remove the last occurrence of a vowel, etc.

7) In any sequence of consecutive consonants in a token remove the entire sequence, remove the first occurrence of a consonant, remove the last occurrence of a consonant, etc.

8) Map a token, or some aspect of a token, to an associated lexeme and using an identified lexeme optionally perform a replacement, substitution, etc. operation.

9) Query a repository for the presence of a token or some aspect of a token and based on the result of the query (i.e., presence or absence) optionally perform one or more of a replacement, substitution, etc. operation; a specific parse rule or parse rule set invocation; etc.

The exemplary actions that were described above are illustrative only and it will be readily apparent to one of ordinary skill in the relevant art that numerous other actions are easily possible and indeed are fully within the scope of the present invention.

The specific exchanges that were described above (as residing under the designation Set 2 in FIG. 4) are illustrative only and it will be readily apparent to one of ordinary skill in the relevant art that numerous other exchanges are easily possible and indeed are fully within the scope of the present invention.

The exchanges that are collected under the designation Set 3 in FIG. 4 represent the activities that might take place as SP 408 AS 412 dispatches one or more reply, update, request, etc. (SMS/MMS/etc.) messages to Mary 402 (436→442) and Mary 402 optionally replies or responds to the message(s) (444→450). Of interest and note are:

1) In the instant example the messages are shown traversing a MICV 406.

2) An SP 408 may employ a SC or a regular TN as its source address (and to which it would ask users of its service to direct any reply messages).

3) The messaging sequences 436→442 and/or 444→450 may be repeated any number of times.

The specific exchanges that were described above (as residing under the designation Set 3) are illustrative only and it will be readily apparent to one of ordinary skill in the relevant art that numerous other exchanges are easily possible and indeed are fully within the scope of the present invention. For example, a SP may optionally complete one or more billing transactions (including possibly inter alia one or more of the forms or types that were described previously). For example, a SP may optionally update one or more elements within an internal repository (including possibly inter alia aspects of one or more MS profiles) to preserve possibly among other things individual payment/coverage/etc. cost, elections, etc.

The Set 1→Set 3 exchanges that were described above are illustrative only and it will be readily apparent to one of ordinary skill in the relevant art that numerous other exchanges are easily possible and indeed are fully within the scope of the present invention. For example, possibly inter alia:

1) A SP may optionally allow a MS to accumulate internal points or credits, cash, etc. as they employ aspects of a SP's services.

2) A MS may be allowed to monitor the status of (a) their accumulated points, credits, cash, etc. and/or (b) aspects of their activities (for example messages sent, messages received, messages for which payment/coverage/etc. was manually elected, messages for which payment/coverage/etc. was automatically elected, the particulars [such as amount, date and time, etc.] for each individual payment/coverage/etc. that was elected, etc.) through any combination of any number of channels including, possibly inter alia, a WWW site, (SMS/MMS/etc.) messaging, IVR, E-mail, postal mail, etc.

3) A MS may be allowed to redeem their accumulated points, credits, cash, etc. as any combination of any number of means (including, possibly inter alia, cash, free service offerings, product coupons and/or discounts, etc.) through any combination of any number of channels (including, possibly inter alia, a MS′ WC [e.g., by communicating, interacting, etc. with the MS′ WC to, possibly inter alia, facilitate the MS receiving their accumulated points/credits/cash/etc. on the MS′ monthly statement], a WWW site, E-mail, postal mail, etc.).

4) A SP may optionally employ a combination of one or more of a range of methods (including, inter alia, statistical, keyword matching, stylistic, linguistic, heuristic, etc.) during one or more of its processing steps.

5) During one or more of its processing steps a SP may optionally score, rate, rank, etc. a developed result and may optionally augment a developed result with such things like demographic, geographic, psychographic, etc. data.

6) A SP may optionally alert a MS to aspects of the SP's proposed keyword, code, indicator, response, etc. interpretation (i.e., the results of the SP's analysis, manipulation, transformation, replacement, etc. operations); optionally allow a MS to accept or decline a proposed interpretation; optionally propose to a MS one or more alternative interpretations (said alternative interpretations possibly leveraging various rules, requirements, parameters, etc. that may be defined for a campaign, initiative, etc.); optionally allow a MS to supply an alternative interpretation; etc. Such activities may, as just one possible example, take place during or following the FIG. 4 Set 2 exchanges that were described above. Such activities may, as just one possible example, include an exchange of one or more SMS/MMS/etc. messages. Additionally, such activities may be repeated any number of times (optionally bounded by, possibly inter alia, a count, a dynamic measure of interpretation ‘closeness,’ etc.)—e.g., as just one possible example, a SP may notify a MS of the SP's proposed interpretation; the MS may decline the proposed interpretation and supply an alternative interpretation; the SP may notify a MS of the SP's proposed interpretation; the MS may decline the proposed interpretation; the SP may propose an alternative interpretation; the MS may accept the proposed interpretation; etc. During such activities a SP may optionally offer to a MS, possibly inter alia, help, suggestions or recommendations, etc.

The confirmation, update, request, alert, etc. message(s) that were described above may optionally contain an informational element—e.g., a relevant or applicable factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Service [LBS], Global Positioning System [GPS], etc. facility).

The confirmation, update, request, alert, etc. message(s) that were identified above may optionally contain advertising—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material that is, for example, selected from a pool of available material), selected randomly (e.g., a generated message is injected with advertising material that is, for example, randomly selected from a pool of available material), or selected based on location (i.e., a generated message is injected with advertising material that is, for example, selected from a pool of available material based on the current physical location of the recipient of the message as derived from, as one example, a LBS, GPS, etc. facility). Third parties (such as, for example, advertising agencies, brands, etc.) may contribute advertising material to a SP's pool of advertising material.

The confirmation, update, request, alert, etc. message(s) that were identified above may optionally contain promotional materials (e.g., still images, video clips, etc.).

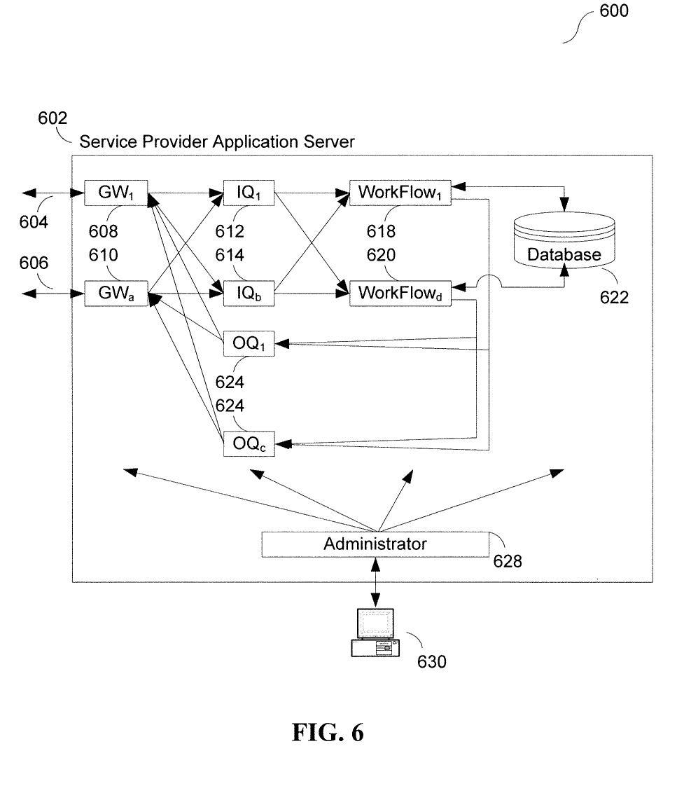

FIG. 6 and reference numeral 600 provides a diagrammatic presentation of aspects of an exemplary SP AS 602. The illustrated AS 602 contains several key components—Gateways (GW₁ 608→GWₐ 610 in the diagram), Incoming Queues (IQ₁ 612→IQ_{b} 614 in the diagram), WorkFlows (WorkFlow₁ 618→WorkFlow_{d} 620 in the diagram), Database 622, Outgoing Queues (OQ₁ 624→OQ_{c} 626 in the diagram), and an Administrator 628. It will be readily apparent to one of ordinary skill in the relevant art that numerous other components are possible within an AS 602. It should be appreciated by those skilled in the art that the foregoing components may be implemented in electronic hardware (e.g., computers, servers, other computing devices, and the like) and/or software running on that hardware as appropriate.

A dynamically updateable set of one or more Gateways (GW₁ 608→GWₐ 610 in the diagram) handle incoming (SMS/MMS/etc. messaging, etc.) traffic and outgoing (SMS/MMS/etc. messaging, etc.) traffic (604→606). Incoming traffic (604→606) is accepted and deposited on an intermediate or temporary Incoming Queue (IQ₁ 612→IQ_{b} 614 in the diagram) for subsequent processing. Processed artifacts are removed from an intermediate or temporary Outgoing Queue (OQ₁ 624→OQ_{c} 626 in the diagram) and then dispatched (604→606).

A dynamically updateable set of one or more Incoming Queues (IQ₁ 612→IQ_{b} 614 in the diagram) and a dynamically updateable set of one or more Outgoing Queues (OQ₁ 624→OQ_{c} 626 in the diagram) operate as intermediate or temporary buffers for incoming and outgoing traffic (604→606).

A dynamically updateable set of one or more WorkFlows (WorkFlow₁ 618→WorkFlow_{d} 620 in the diagram) remove incoming traffic from an intermediate or temporary Incoming Queue (IQ₁ 612→IQ_{b} 614 in the diagram), perform all of the required processing operations (more about this below), and deposit processed artifacts on an intermediate or temporary Outgoing Queue (OQ₁ 624→OQ_{c} 626 in the diagram). The WorkFlow component will be described more fully below.

The Database 622 that is depicted in FIG. 6 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 628 that is depicted in FIG. 6 provides management or administrative control over all of the different components of an AS 602 through, as one example, a WWW-based interface 630. It will be readily apparent to one of ordinary skill in the relevant art that numerous other interfaces (e.g., a data feed, an Application Programming Interface [API], etc.) are easily possible.

Through flexible, extensible, and dynamically updatable configuration information a WorkFlow component may be quickly and easily realized to support any number of activities. For example, WorkFlows might be configured to support a registration process; to support interactions with external entities such as third-parties; to support various of the internal processing steps that were described above (including possibly inter alia the development of tokens; the retrieval, application, etc. of parse rule sets and parse rules; the querying of repositories; etc.); to support the generation and dispatch of outgoing, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, analytical, messaging, etc. activities (e.g., aspects of received monitoring information, generated events, dispatched notification messages, etc.) may be recorded. Among other things, such a repository may be used to support:

1) Scheduled (e.g., daily, weekly, etc.) and/or on-demand reporting with report results delivered through SMS, MMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, etc. messages; through E-Mail; through a WWW-based facility; etc.

It is important to note that while aspects of the discussion that was presented above referenced the use of TNs and SCs it will be readily apparent to one of ordinary skill in the relevant art that other message address identifiers are equally applicable and, indeed, are fully within the scope of the present invention.

The discussion that was just presented referenced the specific wireless messaging paradigms—SMS and MMS. These paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that other paradigms (such as, for example, IMS, IM, E-Mail, Wireless Application Protocol [WAP], etc.) are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following acronyms are employed in this disclosure:

| Acronym | Meaning |
|---|---|
| A2P | Application-to-Peer |
| API | Application Programming Interface |
| AS | Application Server |
| BI | Billing Interface |
| CFG | Context-Free Grammar |
| CSC | Common Short Code |
| DB | Database |
| DBMS | Database Management System |
| DoW | Day of Week |
| E-Mail | Electronic Mail |
| GIS | Geographic Information System |
| GPS | Global Positioning System |
| GW | Gateway |
| HLR | Home Location Register |
| IM | Instant Messaging |
| IMS | IP Multimedia Subsystem |
| IP | Internet Protocol |
| IQ | Incoming Queue |
| IVR | Interactive Voice Response |
| LBS | Location-Based Service |
| MICV | Messaging Inter-Carrier Vendor |
| MMS | Multimedia Message Service |
| MS | Mobile Subscriber |
| NLP | Natural Language Processing |
| ODBMS | Object Database Management System |
| OQ | Outgoing Queue |
| P2P | Peer-to-Peer |
| PC | Personal Computer |
| PDA | Personal Digital Assistant |
| PEG | Parsing Expression Grammar |
| RDBMS | Relational Database Management System |
| SC | Short Code |
| SMS | Short Message Service |
| SP | Service Provider |
| 3P | Third Party |
| TN | Telephone Number |
| ToD | Time of Day |
| WAP | Wireless Application Protocol |
| WC | Wireless Carrier |
| WD | Wireless Device |
| WE | WorkFlow |
| WS | Web Server |
| WWW | World-Wide Web |

What is claimed is:

1. A method for intelligent syntax matching, comprising:
receiving at a gateway an incoming message, the incoming message containing at least a body and having originally been initiated by a mobile subscriber as a wireless message directed to an Application-to-Peer (A2P) initiative;
performing one or more processing steps, using two or more of (a) aspects of the incoming message, (b) information about the mobile subscriber, and (c) parse rules for the A2P initiative, to (a) identify an error in the body of the incoming message and (b) identify a correction to the error;
alerting the mobile subscriber to the correction and, based on any reply from the mobile subscriber, accepting either the correction or an alternative correction supplied by the mobile subscriber; and
updating aspects of an internal repository in light of the correction or alternative correction.

2. The method of claim 1, wherein the information about the mobile subscriber comprises information that is defined by the mobile subscriber during a registration process.

3. The method of claim 2, wherein the registration process captures one or more of (a) Identifying Information and (b) Billing Information.

4. The method of claim 2, wherein the registration process results in a User Profile.

5. The method of claim 2, wherein the registration process is Web-based.

6. The method of claim 2, wherein the registration process includes a billing component.

7. The method of claim 1, wherein the incoming message is one of (a) a Short Message Service message, (b) a Multimedia Message Service message, (c) an IP Multimedia Subsystem message, (d) an Instant Messaging message, (e) an E-Mail message, or (f) a Wireless Application Protocol message.

8. The method of claim 1, wherein the one or more processing steps employ one or more of (a) statistical, (b) keyword matching, (c) stylistic, (d) linguistic, or (e) heuristic techniques.

9. The method of claim 1, wherein the internal repository preserves accumulated (a) points, (b) credits, or (c) cash for the mobile subscriber.

10. The method of claim 1, further comprising:
performing a billing transaction during the one or more processing steps.

11. A system for intelligent syntax matching, comprising:
a gateway at which an incoming message is received, the incoming message containing at least a body and having originally been initiated by a mobile subscriber as a wireless message directed to an Application-to-Peer (A2P) initiative; and
at least one workflow module, the at least one workflow module being operable to:
(a) perform one or more processing steps—using two or more of (i) aspects of the incoming message, (ii) information about the mobile subscriber, and (iii) parse rules for the A2P initiative—to (i) identify an error in the body of the incoming message and (ii) identify a correction to the error;
(b) alert the mobile subscriber to the correction and, based on any reply from the mobile subscriber, accept either the correction or an alternative correction supplied by the mobile subscriber; and
(c) update aspects of an internal repository.
